(19) United States
(12) Patent Application Publication
(10) Pub. No.: US 2016/0309281 A1
(43) Pub. Date: Oct. 20, 2016

(54) WIFI WIRELESS REMOTE CONTROLLER BASED ON WEB SERVER TECHNOLOGY

(71) Applicant: Jen-Ching LEE, New Taipei City (TW)

(72) Inventor: Jen-Ching LEE, New Taipei City (TW)

(21) Appl. No.: 14/715,743

(22) Filed: May 19, 2015

(30) Foreign Application Priority Data
Apr. 16, 2015 (TW) 104205707

(51) Int. Cl. H04W 4/00

(52) U.S. Cl. CPC H04W 4/005; H04W 88/021

(57) ABSTRACT

A WIFI wireless remote controller based on web server technology includes a WIFI network controller and a computer/notebook/Tablet PC/mobile phone. Various remote control models simply need to install the WIFI network controller to achieve the convenient control through the computer/notebook/Tablet PC/mobile phone, so that a convenient sharing effect can be achieved, and the WIFI and webpage technologies are adopted to provide users a convenient way of controlling the WIFI network controller through the present existing WIFI network. In addition to the operation and control of the conventional remote control model, the present invention further provides a convenient way of transmitting images and sensed data and an alternative way of playing by virtual reality, so as to improve the convenience and diversity of uses.

### FIELD OF THE INVENTION

The present invention relates to a WIFI wireless remote controller based on web server technology, in particular to the wireless remote controller connected by a WIFI AP method, and a user may use a computer, tablet PC or a mobile phone browser to obtain parameters from a remote end of the wireless remote controller or control the parameters in an opposite direction by a web server technology.

### BACKGROUND OF THE INVENTION

In general a conventional RC (Remote control) device of a remote control model is comprised of a remote controller, a receiver and several servos, wherein the receiver and the servos are installed in the remote control model, and the receiver and the servos are electrically coupled to each other, and the servos are coupled to a driving element of the model. The player hand the controller, which is transmitting a control message to the receiver of the model, and the RC model is controlled. However, such control mechanism requires the installation of an additional wireless transmitter for the image transmission, and users need to install a screen on the transmitter additionally and cannot integrate the electronic sensor with the image for data transmissions. Therefore, the conventional remote control device still has the drawback of significant inconvenience and low level of integration.

### SUMMARY OF THE INVENTION

In view of the aforementioned drawbacks of the significant inconvenience and the low level of integration of the conventional remote control (RC) device, it is a primary objective of the present invention to overcome the drawbacks by providing a WIFI wireless remote controller based on a web server technology in accordance with the present invention.

To achieve the aforementioned objective, the present invention provides a WIFI wireless remote controller based on a web server technology, comprising: a WIFI remote controller means and a computer/notebook/Tablet PC/mobile phone, wherein the WIFI remote controller means includes a control module, a pulse width modulation integrated circuit (PWM IC) module, a wireless network receiving module (WIFI), a power supply module, a universal serial bus (USB) port module, a plurality of universal asynchronous transmitter/receiver (UART) modules, a data transmission port module (RJ45, Registered Jack), a memory access module (MICRO SD), a plurality of serial communication bus port modules (I²C, Inter-Integrated Circuit), a universal input/output slot module (GP10 Set) and a system indicator, wherein the control module includes a dynamic memory, an embedded data storage memory and a central processing unit (CPU), and the PWM IC module includes a plurality of server ports, and the wireless network receiving module includes a wireless antenna, and the power supply module includes a power management control circuit, a server power switch jumper and a mode selection jumper, and the USB port module is coupled to at least one video recorder/camera (UVC, USB Video Class), and the universal asynchronous transmitter/receiver module is coupled to at least one GPS tracker, and the data transmission port module is coupled to a sonar imaging device or a deep sea unmanned submersible device, and the serial communication bus port module is coupled to at least one electronic sensor, and the electronic sensor is an electronic compass, an accelerator, a gyroscope or a piezometer. The control module is coupled to the PWM IC module, the wireless network receiving module, the power supply module, the USB port module, the universal asynchronous transmitter/receiver module, the data transmission port module, the memory access module, the serial communication bus port module, the universal input/output slot module and the system indicator. In addition, the computer/notebook/Tablet PC/mobile phone comes with a remote WIFI connection function and includes a built-in browser, and the browser is provided for connecting and opening a control interface webpage, and the control interface webpage includes a control column display portion, a remote real-time image display portion, a level information display portion, a compass information display portion, a battery current status indicating portion and a remote real-time information display portion. The computer/notebook/Tablet PC/mobile phone, is connected to the wireless network receiving module of the WIFI remote controller means by a WIFI AP method, and the CPU of the control module 11 comes with a web server function, and the browser of the computer/notebook/Tablet PC/mobile phone is provided for connecting and opening the control interface webpage and inputting control signals from the control column display portion to transmit the control message to the plurality of servo ports of the PWM IC module, and the remote real-time image display portion is provided for receiving and displaying a video stream captured by the video recorder/camera of the USB port module to generate an instant image, and the level information display portion, the compass information display portion and the remote real-time information display portion display the integration of electronic parameters of the electronic sensor of the serial communication bus port module, the GPS tracker of the universal asynchronous transmitter/receiver module, and the sonar imaging device or the deep sea unmanned submersible device of the data transmission port module, and the battery current status indicating portion is provided for monitoring and displaying the electronic parameters including the voltage, the current and the power level of the battery module. Various remote control models simply need to install the WIFI network controller to achieve the convenient control through the computer/notebook/Tablet PC/mobile phone, so that a convenient sharing effect can be achieved, and the WIFI and webpage technologies are adopted to provide users a convenient way of controlling the WIFI network controller through the present existing WIFI network. In addition to the operation and control of the conventional remote control model, the present invention further provides a convenient way of transmitting images and sensed data and an alternative way of playing by virtual reality, so as to improve the convenience and diversity of uses.

### BRIEF DESCRIPTION OF THE DRAWINGS

FIG. 1 is a schematic view of the connection of the present invention with an electronic device;

FIG. 2 is a schematic block diagram showing the details of the components of the present invention;

FIG. 3 is a schematic view showing the interface of a control webpage of the present invention;

FIG. 4 is a schematic view of connecting a WIFI remote controller connected to a computer, a notebook, a tablet PC or a mobile phone in accordance with the present invention;

FIG. 5 is a schematic view of a first embodiment applied to a model car in accordance with the present invention;

FIG. 6 is a schematic view of a second embodiment applied to a model quadcopter in accordance with the present invention;

FIG. 7 is a schematic view of a third embodiment applied to a model submarine in accordance with the present invention;

FIG. 8 is a schematic view of a fourth embodiment applied to a model boat in accordance with the present invention;

FIG. 9 is a schematic view of a fifth embodiment applied to a model submarine in coordination with a robot in accordance with the present invention; and

FIG. 10 is a schematic view of a sixth embodiment applied to a model rocker bogie in coordination with a robot in accordance with the present invention.

### DESCRIPTION OF THE PREFERRED EMBODIMENTS

The present invention will become clearer in light of the following detailed description of an illustrative embodiment of this invention described in connection with the drawings. It is intended that the embodiments and drawings disclosed herein are to be considered illustrative rather than restrictive.

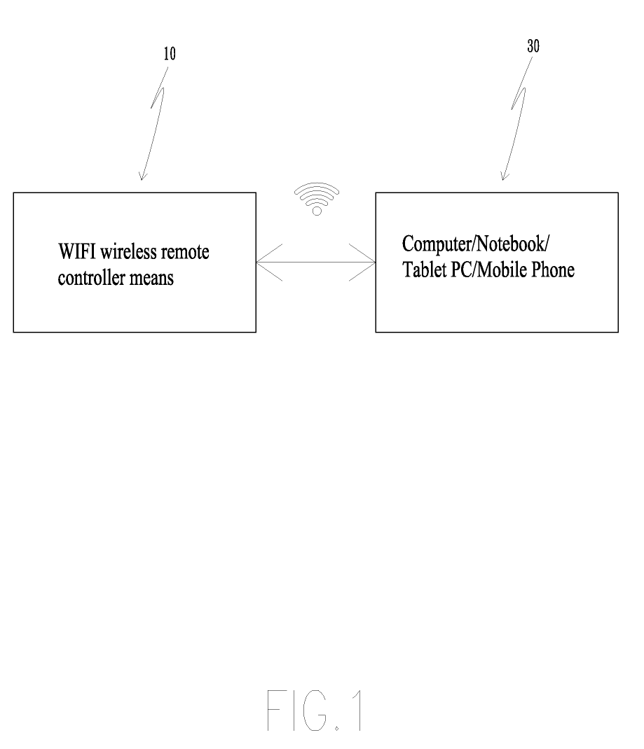

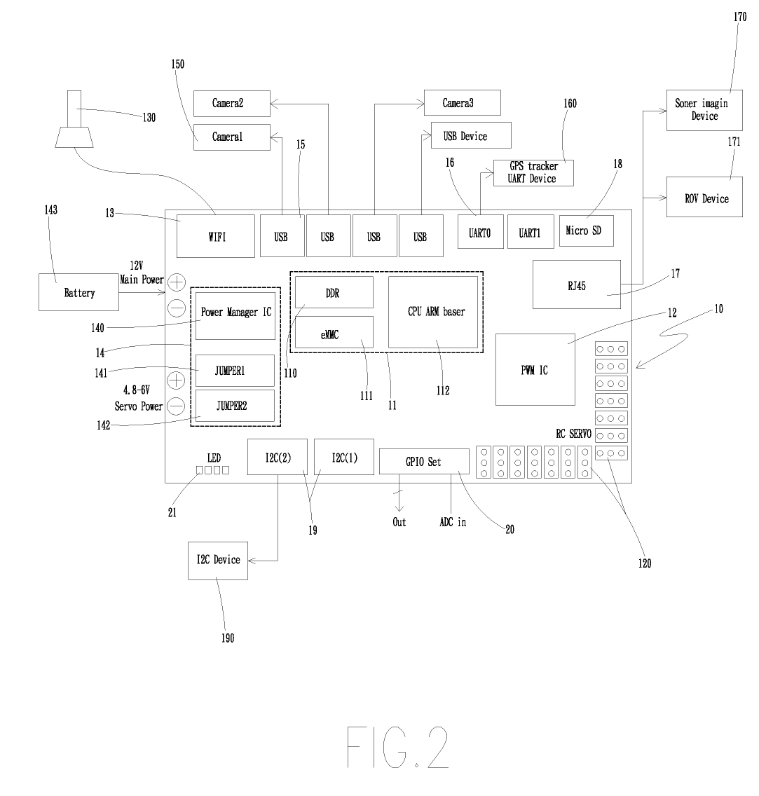

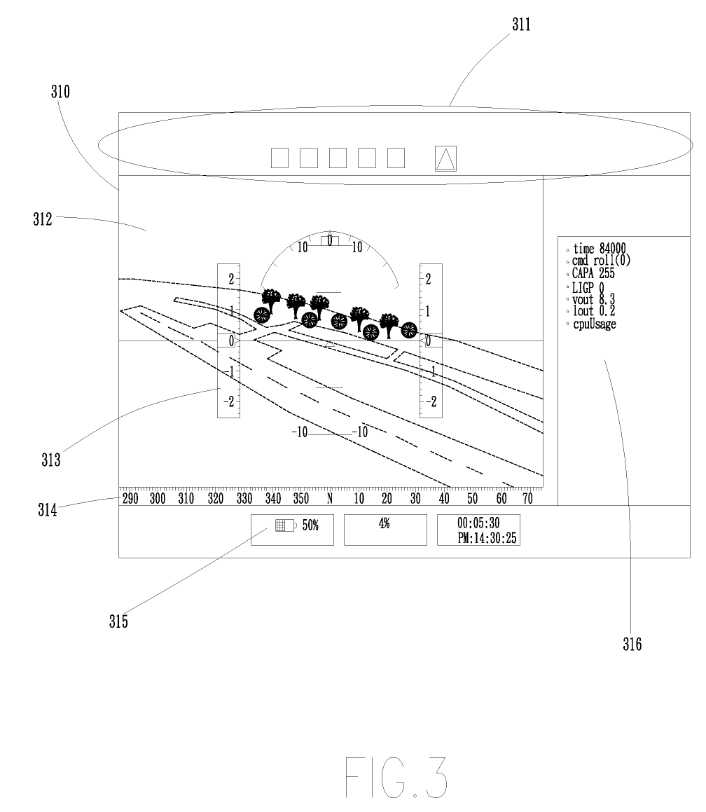

With reference to FIGS. 1 to 3 for a schematic view of the connection of the present invention with an electronic device, a schematic block diagram showing the details of the components of the present invention, and a schematic view showing the interface of a control webpage of the present invention respectively, a WIFI wireless remote controller based on a web server technology comprises the following elements:

A WIFI remote controller means 10 includes a control module 11, a PWM IC module 12, a wireless network receiving module 13, a power supply module 14, a USB port module 15, a plurality of universal asynchronous transmitter/receiver modules 16, a data transmission port module 17, a memory access module 18, a plurality of serial communication bus port modules 19, a universal input/output slot module 20 and a system indicator 21. The control module 11 includes a dynamic memory 110, an embedded data storage memory 111 and a CPU 112. The PWM IC module 12 is coupled to a plurality of servo ports 120, and the wireless network receiving module 13 includes a wireless antenna 130, and the power supply module 14 includes a power management control circuit 140, a servo power switch jumper 141 and a mode selection jumper 142, and the USB port module 15 is coupled to at least one video recorder/camera 150, and the universal asynchronous transmitter/receiver module 16 is coupled to at least one GPS tracker 160, and the data transmission port module 17 is coupled to a sonar imaging device 170 or a deep sea unmanned submersible device 171, and the serial communication bus port module 19 is coupled to at least one electronic sensor 190, and the electronic sensor 190 is an electronic compass, an accelerator, a gyroscope or a piezometer, and the control module 11 is coupled to the PWM IC module 12, the wireless network receiving module 13, the power supply module 14, the USB port module 15, the universal asynchronous transmitter/receiver module 16, the data transmission port module 17, the memory access module 18, the serial communication bus port module 19, the universal input/output slot module 20 and the system indicator 21. The memory access module 18 is provided for the video recorder/camera 150 of the USB port module 15, the GPS tracker 160 of the universal asynchronous transmitter/receiver module 16, the sonar imaging device 170 or the deep sea unmanned submersible device 171 of the data transmission port module 17, and the electronic sensor 190 of the serial communication bus port module 19 to access the generated image and data, and the CPU 112 comes with a web server function.

A computer/notebook/Tablet PC/mobile phone 30 comes with a remote WIFI connection function and has a built-in browser 31 (not shown in the figure) for connecting and opening a control interface webpage 310, and the control interface webpage 310 has a control column display portion 311, a remote real-time image display portion 312, a level information display portion 313, a compass information display portion 314, a battery current status indicating portion 315 and a remote real-time information display portion 316. The computer/notebook/Tablet PC/mobile phone 30 is connected to the wireless network receiving module 13 of the WIFI remote controller means 10 and logged on by a WIFI AP method.

The WIFI wireless remote controller based on web server technology in accordance with the present invention is formed by assembling the aforementioned components.

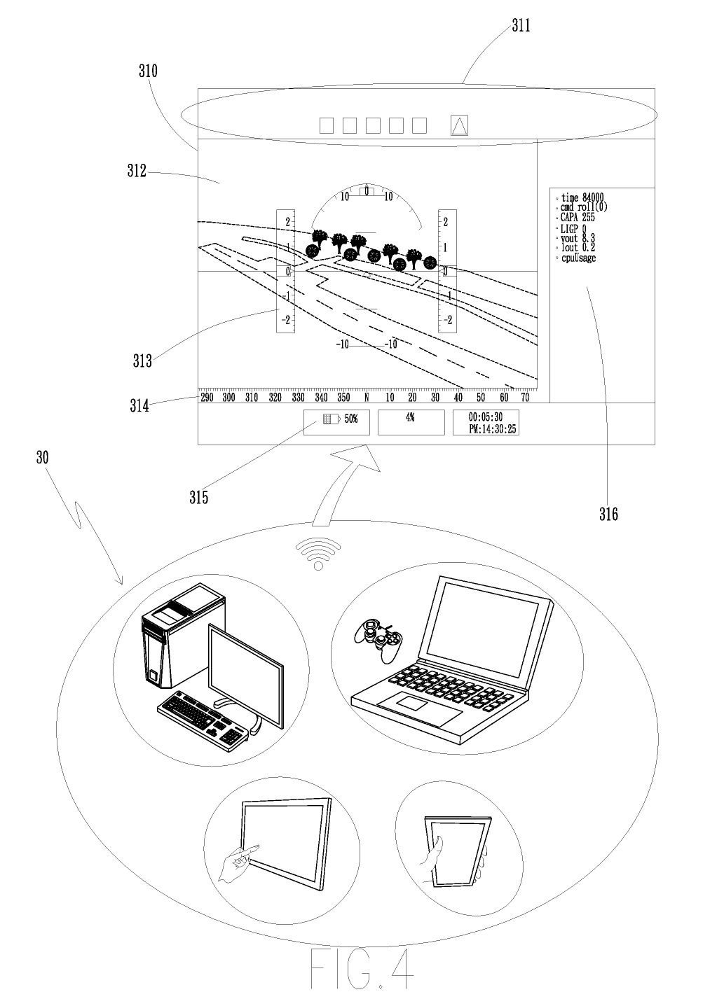

With reference to FIGS. 1 to 4 for a schematic view of the connection of the present invention with an electronic device, a schematic block diagram showing the details of the components of the present invention, a schematic view showing the interface of a control webpage of the present invention, and a schematic view of connecting a WIFI remote controller connected to a computer, a notebook, a tablet PC or a mobile phone in accordance with the present invention respectively, the computer/notebook/Tablet PC/mobile phone 30 is connected to the wireless network receiving module 13 of the WIFI remote controller means 10 and logged on by a WIFI AP method, and the CPU 112 of the control module 11 comes with a web server function. The browser 31 of the computer/notebook/Tablet PC/mobile phone 30 connects and opens the control interface webpage 310, and a control signal may be inputted from the control column display portion 311 to transmit a control message to a plurality of servo ports 120 of the PWM IC module 12, and the remote real-time image display portion 312 receives and displays a video stream captured by the video recorder/camera 150 of the USB port module 15 to generate an instant image, and the level information display portion 313, the compass information display portion 314 and the remote real-time information display portion 316 display the integration of electronic parameters of the electronic sensor 190 of the serial communication bus port module 19, the GPS tracker 160 of the universal asynchronous transmitter/receiver module 16, the sonar imaging device 170 or the deep sea unmanned submersible device 171 of the data transmission port module 17, and the battery current status indicating portion 315 monitors and displays the electronic parameters including the voltage, the current and the power level of the battery module 14.

Various remote control models simply need to install the WIFI network controller 10 to achieve the convenient control through the computer/notebook/Tablet PC/mobile phone 30, so that a convenient sharing effect can be achieved, and the WIFI and webpage technologies are adopted to provide users a convenient way of controlling the WIFI network controller through the present existing WIFI network 10. In addition to the operation and control of the conventional remote control model, the present invention further provides a convenient way of transmitting images and sensed data and an alternative way of playing by virtual reality, so as to improve the convenience and diversity of uses.

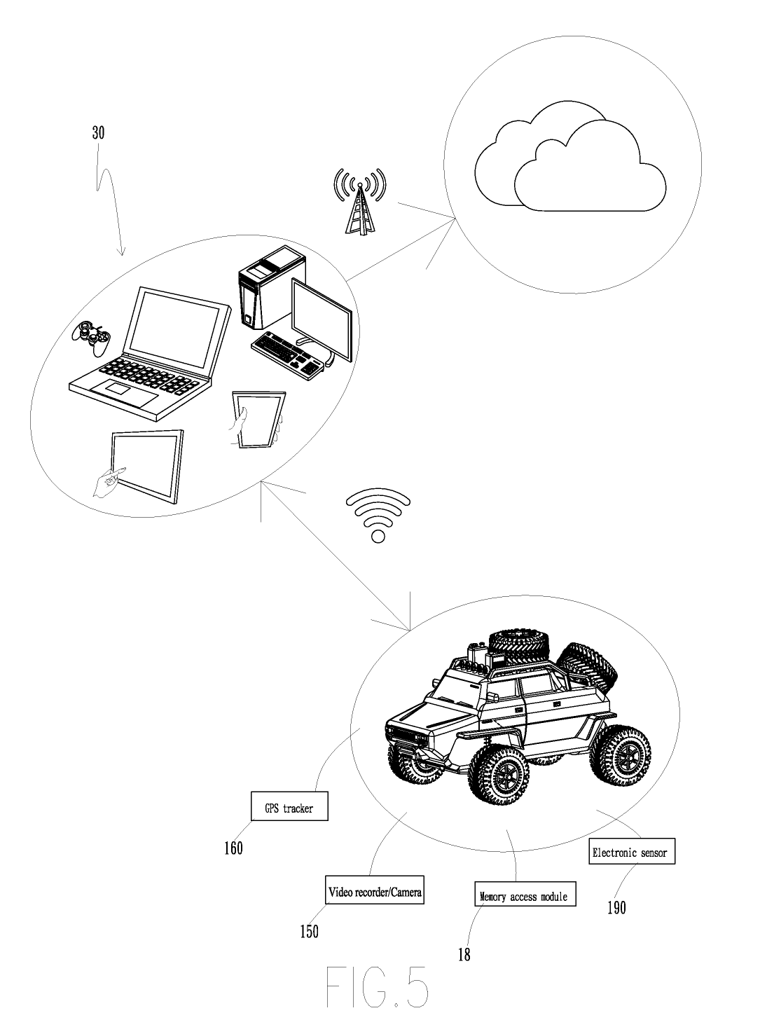

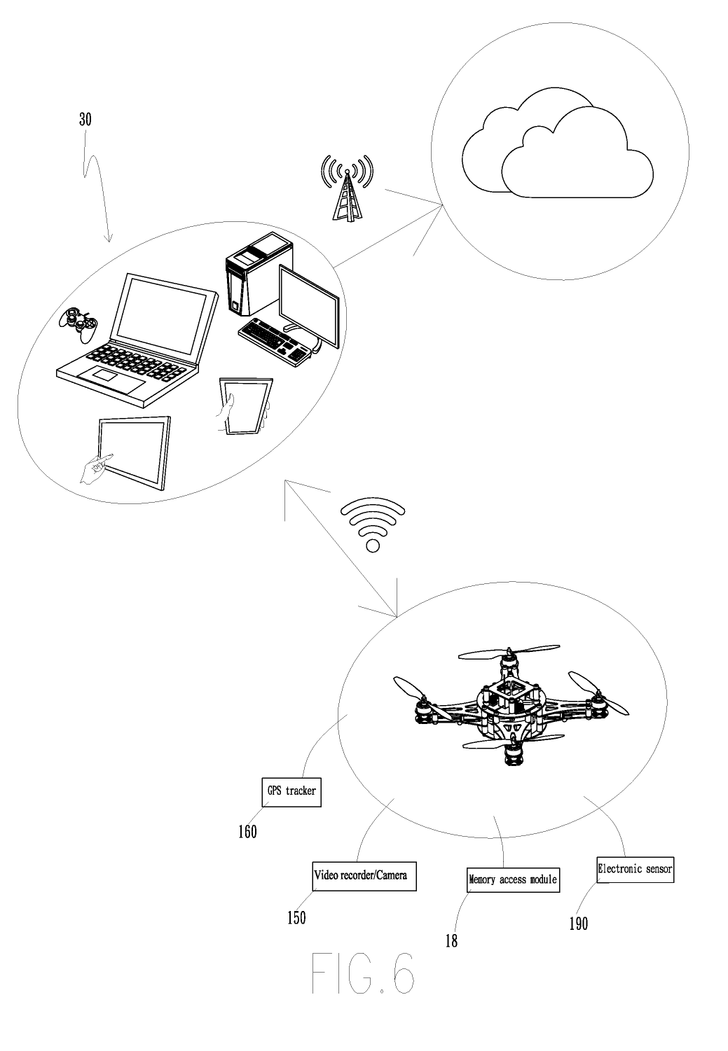

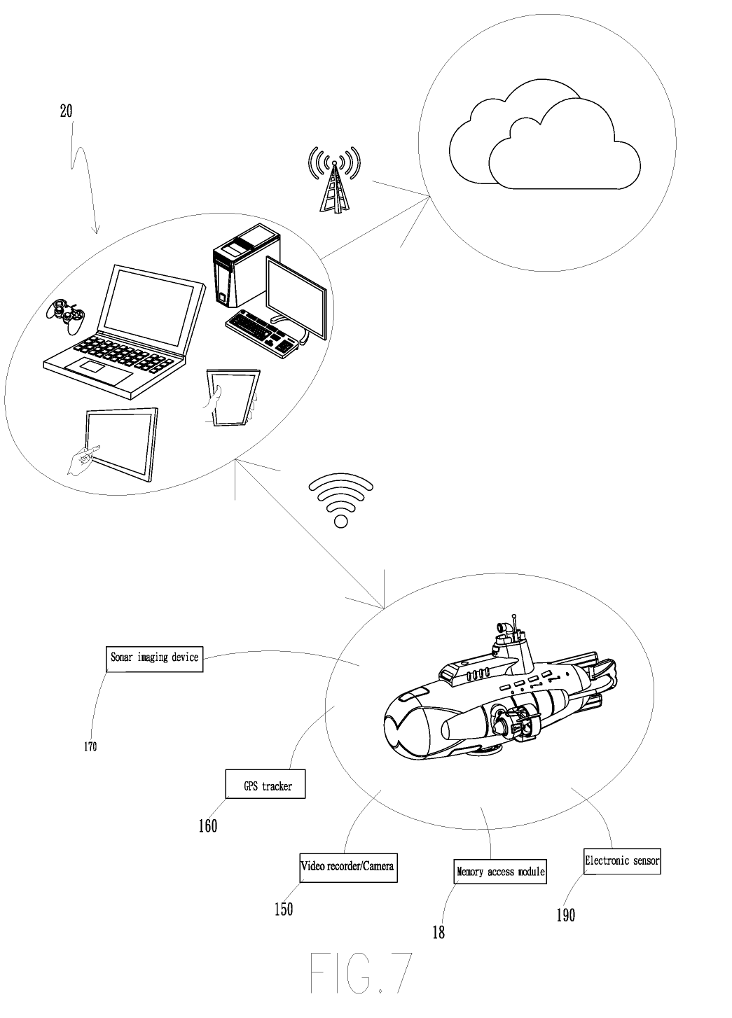

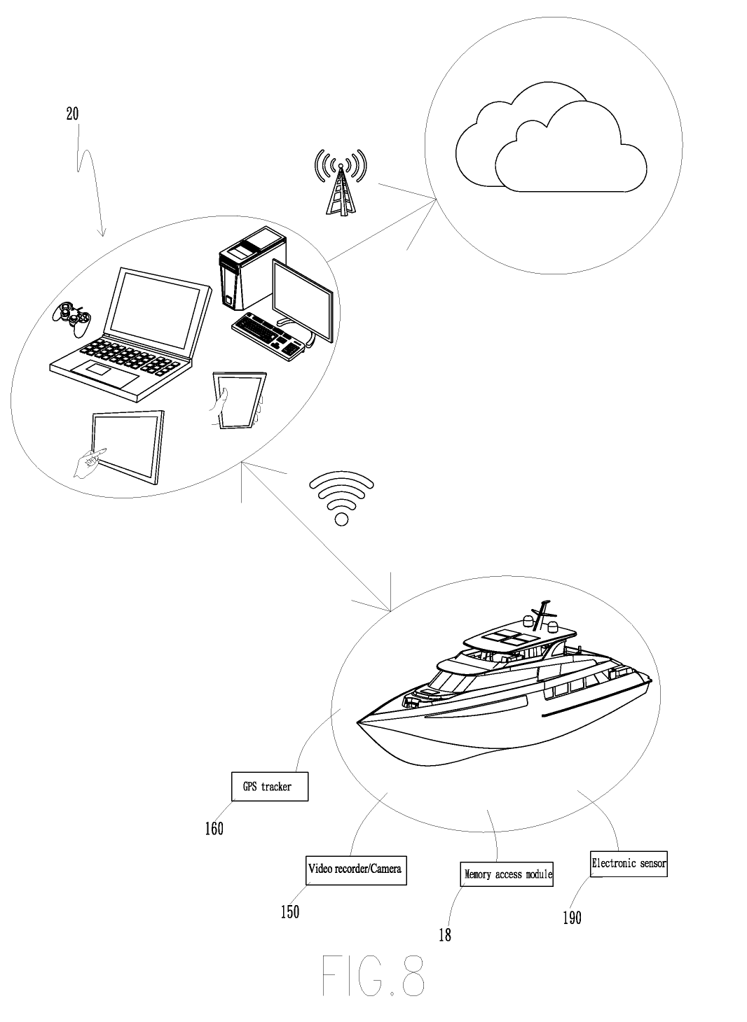

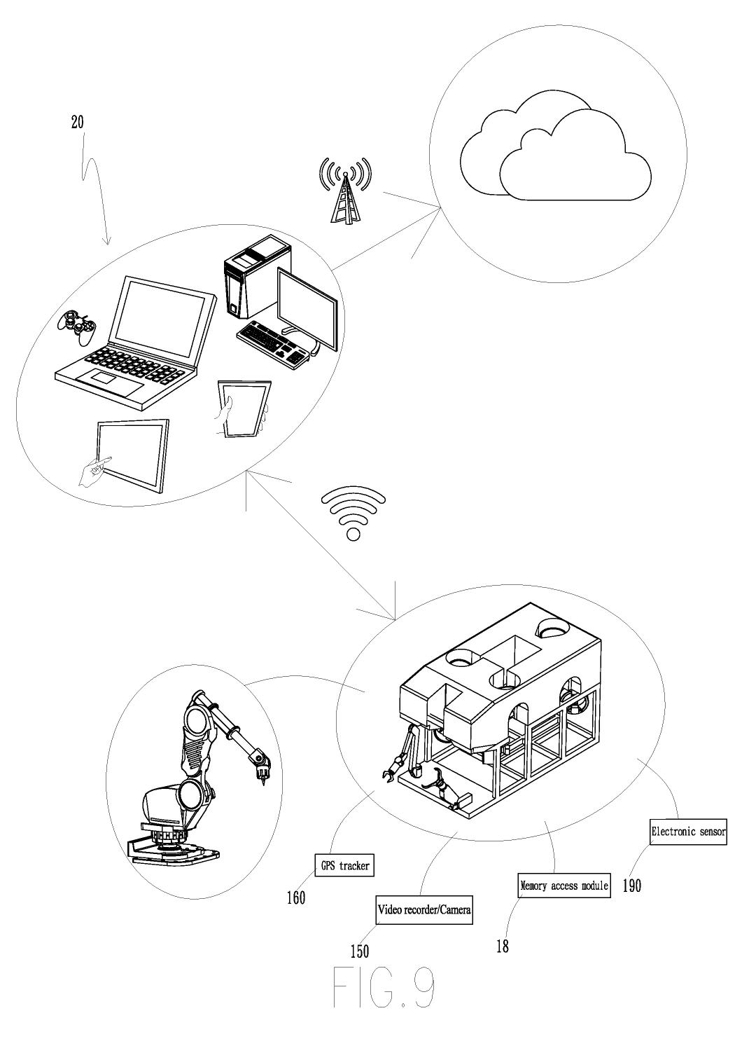

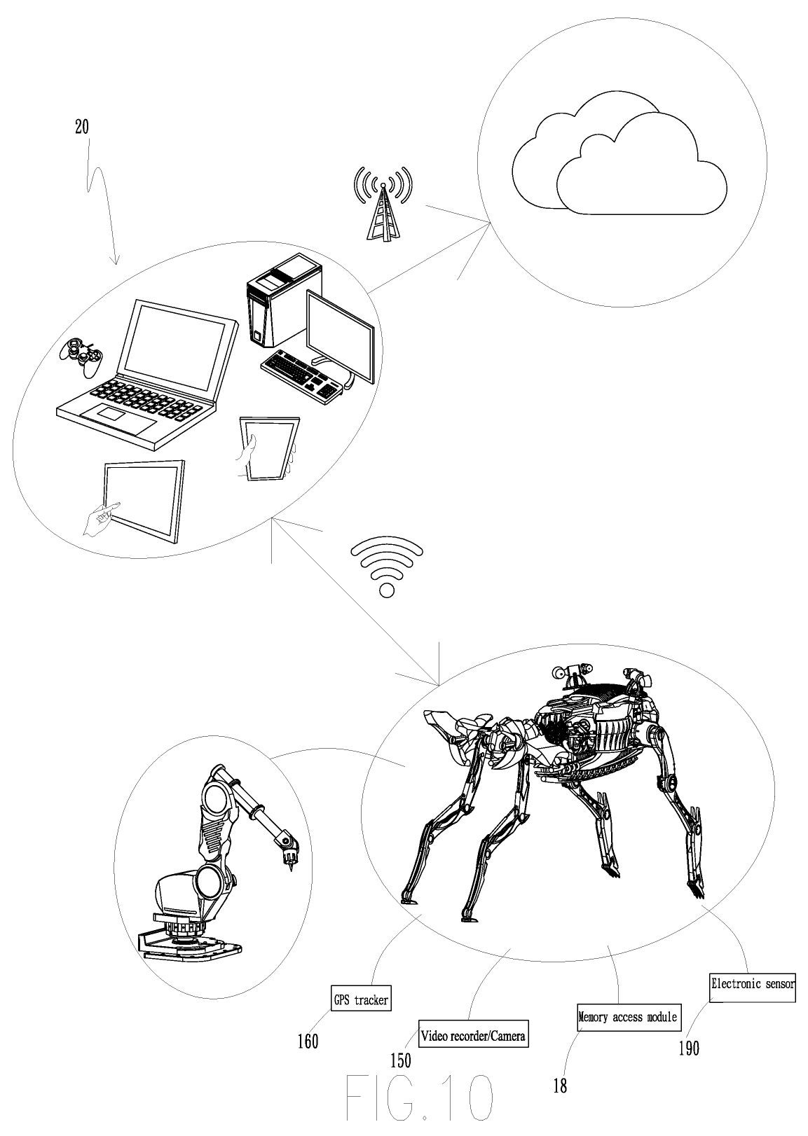

With reference to FIGS. 5 to 10 for the schematic views of the first to sixth embodiments applied to a model car, a model quadcopter, a model submarine, a model boat, a model submersible device operated with a robot, and a model rocker bogie operated with a robot in accordance with the present invention respectively, the overall structure of these embodiments are the same as those illustrated in FIGS. 1 to 4, but the WIFI remote controller means 10 may be installed to a model car, a model quadcopter, a model submarine, a model boat, a model submersible device or a model rocker bogie and operated together with a robot, and the robot is connected to the USB port module 15 of the WIFI remote controller means 10, so that the WIFI remote controller means can drive, monitor and operate the model through the computer/notebook/Tablet PC/mobile phone 30, or upload the instant image generated by the video stream that is captured by the video recorder/camera 150 installed at the USB port module 15 of the WIFI remote controller means 10 through the computer/notebook/Tablet PC/mobile phone 30 to a cloud network device or a specific social web, so as to enhance the diversified uses of the present invention.

What is claimed is:

1. A wireless fidelity (WIFI) wireless remote controller based on web server technology, comprising:
a WIFI remote controller means, having a control module, a power width modulation integrated circuit (PWM IC) module, a wireless network receiving module, a power supply module, a universal serial bus (USB) port module, a plurality of universal asynchronous transmitter/receiver modules, a data transmission port module, a memory access module, a plurality of serial communication bus port modules, a universal input/output slot module and a system indicator, and the control module having a dynamic memory, an embedded data storage memory and a central processing unit (CPU), and the PWM IC module being coupled to a plurality of servo ports, and the power supply module having a power management control circuit, a server power switch jumper and a mode selection jumper, and USB port module being coupled to at least one video recorder/camera, and the universal asynchronous transmitter/receiver module being coupled to at least one GPS tracker, and the serial communication bus port module being coupled to at least one electronic sensor, and the control module being coupled to the PWM IC module, the wireless network receiving module, the power supply module, the USB port module, the universal asynchronous transmitter/receiver module, the data transmission port module, the memory access module, the serial communication bus port module, the universal input/output slot module and the system indicator, and the memory access module being provided for the video recorder/camera of the USB port module, the GPS tracker of the universal asynchronous transmitter/receiver module, the electronic sensors of the data transmission port module and the serial communication bus port module to access generated images and data, and the CPU having a web server function; and
a computer/notebook/Tablet PC/mobile phone, having a remote WIFI connection function, and a built-in browser provided for connecting and opening a control interface webpage, and the control interface webpage having a control column display portion, a remote real-time image display portion, a level information display portion, a compass information display portion, a battery current status indicating portion and a remote real-time information display portion, and the computer/notebook/Tablet PC/mobile phone being connected to the wireless network receiving module of the WIFI remote controller means and logged on by a WIFI AP method.

2. The WIFI wireless remote controller based on web server technology as claimed in claim 1, wherein the computer/notebook/Tablet PC/mobile phone is logged on the WIFI AP by a web server technology to connect the wireless network receiving module of the WIFI remote controller means, and the CPU of the control module comes with a web server function, and the browser of the computer/notebook/Tablet PC/mobile phone connects and opens the control interface webpage, and the control column display portion inputs a control signal to transmit a control message to a plurality of servo ports of the PWM IC module, and the remote real-time image display portion receives and displays a video stream captured by the video recorder/camera of the USB port module to generate an instant image, and the level information display portion, the compass information display portion and the remote real-time information display portion display the integration of electronic parameters of the electronic sensor of the serial communication bus port module, the GPS tracker of the universal asynchronous transmitter/receiver module, and the battery current status indicating portion monitors and displays the electronic parameters including the voltage, the current and the power level of the battery module.

3. The WIFI wireless remote controller based on web server technology as claimed in claim 1, wherein the computer/notebook/Tablet PC/mobile phone uploads the instant image of the video stream captured by the video recorder/camera installed at the USB port module of the WIFI remote controller means to a cloud network device or a specific social web.

4. The WIFI wireless remote controller based on web server technology as claimed in claim 1, wherein the wireless network receiving module of the WIFI remote controller means includes a wireless antenna.

5. The WIFI wireless remote controller based on web server technology as claimed in claim 1, wherein the data transmission port module of the WIFI remote controller means is coupled to a sonar imaging device or a deep sea unmanned submersible device, and the integration of the electronic parameters of the sonar imaging device or the deep sea unmanned submersible device is displayed by the level information display portion, the compass information display portion, and the remote real-time information display portion of the control interface webpage of the browser of the computer/notebook/Tablet PC/mobile phone.

6. The WIFI wireless remote controller based on web server technology as claimed in claim 1, wherein the USB port module of the WIFI remote controller means is coupled to a robot, and the robot is controlled by the computer/notebook/Tablet PC/mobile phone.

7. The WIFI wireless remote controller based on web server technology as claimed in claim 1, wherein the electronic sensor coupled to the serial communication bus port module of the WIFI remote controller means is an electronic compass, an accelerator, a gyroscope or a piezometer.

8. The WIFI wireless remote controller based on web server technology as claimed in claim 1, wherein the WIFI remote controller means is installed to a model car, a model quadcopter, a model submarine, a model boat, a model submersible device or a model rocker bogie, and driven, monitor, and operated by the computer/notebook/Tablet PC/mobile phone.
